(19) United States
(12) Patent Application Publication
(10) Pub. No.: US 2014/0218288 A1
(43) Pub. Date: Aug. 7, 2014

(54) DISPLAY DEVICE, DISPLAY CONTROL METHOD, AND PROGRAM

(71) Applicant: Kenichi Kitatani, Kanagawa (JP)

(72) Inventor: Kenichi Kitatani, Kanagawa (JP)

(73) Assignee: NEC CASIO MOBILE COMMUNICATIONS, LTD., Kanagawa (JP)

(21) Appl. No.: 14/343,236

(22) PCT Filed: Sep. 3, 2012
(86) PCT No.: PCT/JP2012/072347

§ 371 Date: Mar. 6, 2014

(30) Foreign Application Priority Data
Sep. 22, 2011 (JP) 2011-207779

(51) Int. Cl. G06F 3/01

(52) U.S. Cl. CPC G06F 3/011
USPC 345/156

(57) ABSTRACT

A display device includes device body 10 that includes display means 11, motion detection means 13 that detects the motion of device body 10, motion detection means 14 that detects the motion of a holder that holds device body 10, and control means 12 that detects an operation of device body 10 based on the detection results of motion detection means 13 and 14, and controls the displaying of display means 11 according to the detected operation.

### TECHNICAL FIELD

The present invention relates to a technology for displaying a desired region in two-dimensional or three-dimensional virtual space.

### BACKGROUND ART

There is known a virtual space access system that displays a desired region in two-dimensional or three-dimensional virtual space.

For example, Patent Literature 1 describes a mobile terminal that accesses a virtual space in which an application screen is arranged.

The mobile terminal described in Patent Literature 1 includes an acceleration sensor, a motion data calculation unit, a screen arrangement unit, a table, a screen moving unit, a display ratio calculation unit, and an input device.

The acceleration sensor detects the motion of a mobile terminal body. The motion data calculation unit calculates motion data indicating the motion of the mobile terminal body based on the output signal of the acceleration sensor. The screen arrangement unit arranges an application screen in the virtual space.

The display device displays a region in the virtual space. The table stores information associating the motion data with a screen scrolling direction in the virtual space.

When the acceleration sensor detects the motion of the mobile terminal body in the state in which the region in the virtual space is displayed by the display device, the screen moving unit refers to the table to determine a screen scrolling direction corresponding to the motion data, and moves the region in the virtual space displayed by the display device in the determined screen scrolling direction.

When an application screen is present in the region in the virtual space displayed by the display device, the display ratio calculation unit calculates the display ratio of the application screen occupying the region in the virtual space displayed by the display device. Then, when the display ratio is equal to or more than a predetermined value, the input device receives operations with respect to an application.

Patent Literature 2 describes a display device that displays a virtual video, and a video sensing apparatus that uses the same.

The display device described in Patent Literature 2 includes a device body that includes a video display device having a video displayable region wider than an actual video display region, displacement detection means for detecting the displacement of the device body, and display control means for correcting the displacement of a video displayed in the video display device.

The display device, which is a head mount display, is mounted on a head portion. A user observes the video displayed in the video display device. For example, when a head is moved, a video region on the screen of the video display device moves interlockingly with the motion. The movement of the video region is observed as a video blur.

According to the display device described in Patent Literature 2, the video blur is corrected based on the displacement detection result of the device body. Thus, even when the head is moved, the video is displayed at the same position on the screen.

The video sensing device described in Patent Literature 2, which uses the display device together with an attitude changing device, includes base attitude detection means for detecting the motion of the base of the attitude changing device, and optimizes the display position of the video in the video display device based on displacement obtained by subtracting the motion component of the base detected by the base attitude detection means from the detection result of the displacement detection means of the display device. Thus, even when the user having the display device mounted thereon uses the attitude changing device, the video is displayed at the same position on the screen.

### RELATED ART LITERATURE

### Patent Literature

Patent Literature 1: JP2001-18161A

Patent Literature 2: JP11-202257A

### DISCLOSURE OF THE INVENTION

In the mobile terminal described in Patent Literature 1, the acceleration sensor attached to the device body detects the motion of the mobile terminal body, and the scrolling of the screen is carried out interlockingly with the detected motion. However, in this control, the acceleration sensor detects motions that are not related to operations of the mobile terminal body, such as the movement of the user holding the mobile terminal body or changing of the direction of the body. Thus, the display of the screen may be changed according to the operation of the mobile device that is not intended by the user.

In Particular, when the amount of movement by the user who is holding the mobile terminal body is large, for example, when the user moves by transportation means such as a train in the state in which the region in the virtual space is displayed by the display device, the mobile terminal body moves out of the range of the virtual space, thus displaying no video on the screen.

In the display device described in Patent Literature 2, even when the user having the display device mounted thereon moves, the video is displayed at the same position on the screen. Thus, a problem such at that described above, namely, changing of the screen display by an operation unrelated to the operation of the display device and unintended by the use, does not occur. In this case, however, even if any operation is carried out on the display device, the video is displayed at the same position on the screen. Consequently, a region different from the currently displayed region cannot be displayed in the virtual space. A similar problem occurs in the video sensing device.

It is an object of the present invention to provide a display device, a display control method, and a program capable of preventing a screen display from being changed by an operation that is not intended by the user.

To achieve the object, a display device according to the resent invention includes:

a device body that includes display means;

first motion detection means for detecting the motion of the device body;

second motion detection means for detecting the motion of a holder that holds the device body; and

control means for detecting an operation of the device body based on the detection results of the first and second motion detection means, and controlling the displaying of the display means according to the detected operation.

A display control method according to the present invention includes:

detecting the motion of a device body that includes display means, and detecting the motion of a holder that holds the device body; and

detecting an operation of the device body based on the motion detection result of the device body and the motion detection result of the holder, and controlling the displaying of the display means according to the detected operation.

A program according to the present invention causes a computer to execute:

the processing for detecting, based on a first detection result of detecting the motion of a device body that includes display means and a second detection result of detecting the motion of a holder that holds the device body, an operation of the device body; and

the processing for controlling the displaying of the display means according to the detected operation.

### BRIEF DESCRIPTION OF DRAWINGS

FIG. 1 A block diagram showing the configuration of a display device according to the first exemplary embodiment of the present invention.

FIG. 2 A flowchart showing one procedure of operation detection processing performed in the display device shown in FIG. 1.

FIG. 3 A block diagram showing the configuration of a virtual space access device according to the second exemplary embodiment of the present invention.

FIG. 4 A flowchart showing one procedure of access processing performed in the virtual space access device shown in FIG. 3.

FIG. 5 A schematic diagram showing an example of accessing a virtual space not accompanied by any movement such as walking by the user, which is performed in the virtual space access device shown in FIG. 3.

FIG. 6 A schematic diagram illustrating a comparative example of accessing a virtual space.

FIG. 7 A schematic diagram showing an example of accessing the virtual space accompanied by movement such as walking by the user, which is performed in the virtual space access device shown in FIG. 3.

FIG. 8 A diagram illustrating the acceleration information of the motion detection means of the virtual space access device shown in FIG. 3.

### DESCRIPTION OF REFERENCE NUMERALS

10 Device body
11 Display means
12 Control means
13, 14 Motion detection means

### MODE FOR CARRYING OUT THE INVENTION

Hereinafter, exemplary embodiments of the present invention will be described with reference to the drawings.

### First Exemplary Embodiment

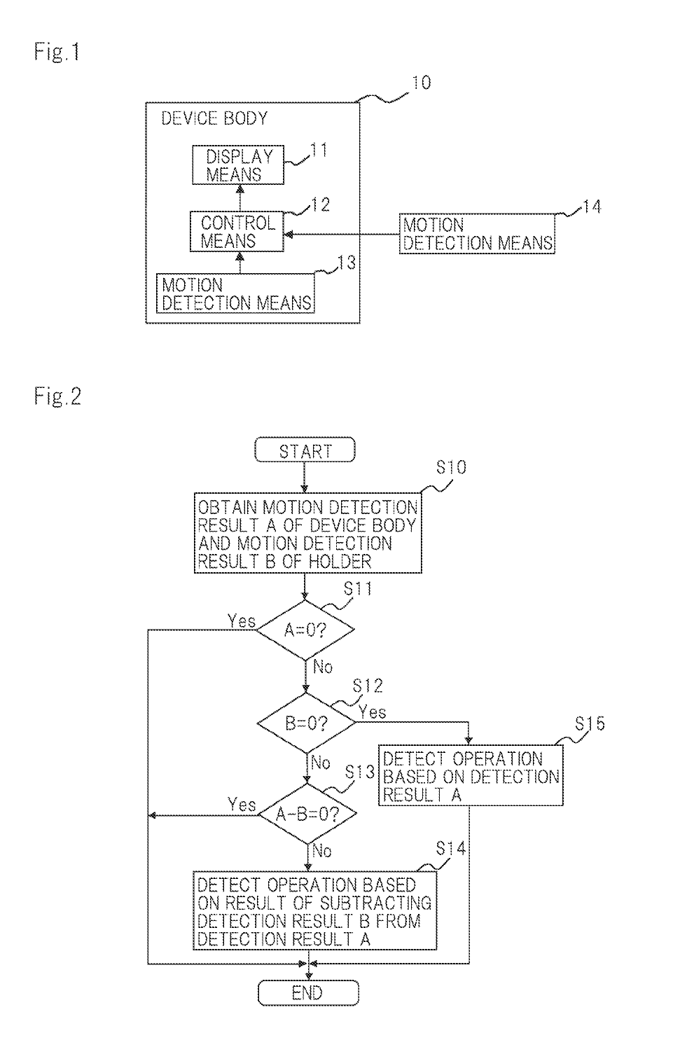

FIG. 1 is a block diagram showing the configuration of a display device according to the first exemplary embodiment of the present invention.

The display device shown in FIG. 1 includes device body 10 that includes display means 11, control means 12, and motion detection means 13, and motion detection means 14 for detecting the motion of a holder that holds device body 10. The holder is a person or a wheel chair.

Display means 11, which is a display device such as a liquid crystal display, displays, for example, a partial region of a two-dimensional or three-dimensional virtual space.

Motion detection means 13 detects, as the motion of device body 10, at least one of movement and an attitude change. The attitude change includes a change of inclination and a change of orientation (direction). An acceleration sensor, a magnetic sensor, or a combination thereof can be used as motion detection means 13.

Motion detection means 14 detects, as the motion of the holder, at least one of movement and an attitude change. The attitude change includes a change of inclination and a change of orientation (direction). An acceleration sensor, a magnetic sensor, or a combination thereof can be used as motion detection means 14.

Communication between motion detection means 14 and control means 12 can be carried out by wireless or via a communication line. The detection results of motion detection means 13 and motion detection means 14 are supplied to control means 12.

Control means 12 detects an operation to device body 10 based on the detection results of motion detection means 13 and motion detection means 14, and controls the displaying of display means 11 according to the detected operation.

In the display device according to the embodiment, when the operation of moving or inclining device body 10 in a desired direction is performed, control means 12 receives an operation to device body 10 via motion detection means 13 and 14 to control the displaying of display means 11.

Hereinafter, the operation of detecting the operation to device body 10 based on the detection results of motion detection means 13 and 14 will specifically be described.

Motion detection means 13 is mounted on device body 10. Accordingly, when the holder moves while an operation to device body 10 is carried out, motion detection means 13 detects the motion of device body 10 according to the operation, and simultaneously detects the motion of device body 10 accompanying the movement of the holder. In other words, the detection result of motion detection means 13 includes the motion component of device body 10 according to the operation, and the motion component of device body 10 accompanying the movement of the holder.

On the other hand, motion detection means 14 detects the movement of the holder. The detection result of motion detection means 14 corresponds to the motion component of device body 10 accompanying the movement of the holder among the detection results of motion detection means 13. Accordingly, the motion component of device body 10 according to the operation can be extracted by subtracting the detection result of motion detection means 14 from that of motion detection means 13. Control means 12 can detect the operation to device body 10 based on the motion component of device body 10 according to the operation.

When the holder moves without any operation to device body 10, motion detection means 13 detects the motion of device body 10 accompanying the movement of the holder. In this case, the detection result of motion detection means 13 includes only the motion component of device body 10 accompanying the movement of the holder. On the other hand, motion detection means 14 detects the movement of the holder. Accordingly, motion accompanying the movement of the holder is canceled by subtracting the detection result of motion detection means 14 from that of motion detection means 13. As a result, motion detection means 13 does not detect any motion of device body 10, and control means 12 determines that no operation to device body 10 has been performed.

When an operation to device body 10 is performed without moving the holder, motion detection means 13 detects the motion of device body 10 according to the operation. In this case, the detection result of motion detection means 13 includes only the motion component of device body 10 according to the operation. On the other hand, motion detection means 14 does not detect the movement of the holder. Accordingly, control means 12 detects the operation to device body 10 only from the motion component of device body 10 according to the operation detected by motion detection means 13.

The aforementioned operation is only for the movements of device body 10 and the holder. For the attitude changes of device body 10 and the holder, an operation can be detected by similar control as well.

FIG. 2 is a flowchart showing one procedure of processing to detect an operation to device body 10.

Hereinafter, the processing procedure of operation detection will be described referring to FIGS. 1 and 2.

First, control means 12 obtains detection result A from motion detection means 13 and detection result B from motion detection means 14 (step S10). Detection results A and B are obtained at every fixed time.

Then, control means 12 determines whether detection result A is 0 (step S11).

When the determination result of step S11 is “No”, then, control means 12 determines whether detection result B is 0 (step S12).

When the determination result of step S12 is “No”, then, control means 12 determines whether the result of subtracting detection result B from detection result A is 0 (step S13).

When the determination result of step S13 is “No”, control means 12 detects an operation to device body 10 based on the result of subtracting detection result B from detection result A (step S15). Then, control means 12 controls the displaying of display means 11 according to the detected operation.

When the determination result of step S11 is “Yes”, and the determination result of step S13 is “Yes”, the processing to detect an operation is ended.

When the determination result of step S12 is “Yes”, control means 12 detects an operation to device body 10 based on detection result A (step S15). Then, control means 12 controls the displaying of display means 11 according to the detected operation.

According to the processing as described above, the operation to device body 10 can be definitely detected by cancelling the motion component of device body 10 accompanying the movement or the attitude change of the holder. Thus, operations unintended by the user can be prevented.

In the procedure shown in FIG. 2, steps S11, S12, and S15 can be omitted. In such a case, the operation to device body 10 can be surely detected through a simpler procedure.

The display device according to the embodiment may be configured so that the motion component of the holder detected by motion detection means 14 can roughly match that of device body 10 accompanying the movement of the holder detected by motion detection means 13. Thus, the detection accuracy of the operation to device body 10 can be improved.

Hereinafter, a specific example for improving the detection accuracy of the operation will be described. The description will be made by taking the example of a situation where device body 10 is operated with one hand.

When a holding user walks while operating device body 10 with one hand, motion detection means 13 simultaneously detects the motion of device body 10 according to the operation and the motion of device body 10 accompanying the movement of the holding user.

In the aforementioned case, as long as motion detection means 14 can detect only the movement of the holding user without detecting the motion of the hand, the motion component of the holder detected by motion detection means 14 roughly matches the motion component of device body 10 accompanying the movement of the holder detected by motion detection means 13.

Motion detection means 14, which can detect only the movement of the holding user without detecting the motion of the hand, includes, for example, a plurality of acceleration sensors. Specifically, the plurality of acceleration sensors is mounted on the holder, and control means 12 detects the movement of the holder based on an average value among the outputs of the acceleration sensors.

In addition, a plurality of acceleration sensors capable of detecting the center of gravity of the holder can be used as motion detection means 14. Specifically, the plurality of acceleration sensors is mounted on the holder so that the center of gravity of the holder can be detected, and control means 12 detects the movement of the center of gravity of the holder based on the output value of each acceleration sensor.

In the display device according to the embodiment, when the holder that holds device body 10 is a moving object such as a wheelchair, the moving object includes a base for holding device body 10 to be rotatable or movable. Motion detection means 14 is mounted on a portion other than the base of the moving object.

In the display device according to the embodiment, when motion detection means 13 and 14 are configured by using magnetic sensors, motion detection means 13 detects a change in orientation of the device body while motion detection means 14 detects a change in orientation of the holder. In this case, the operation to device body 10 can be detected by canceling the motion component of device body 10 accompanying the change in orientation of the holder. For example, while the holding user moves by transportation means such as a car, even if the orientations of the transportation means and the holding user change, the display will never change. This is effective, for example, in the case of arranging an object indicating orientation in the virtual space by navigation.

When motion detection means 13 and 14 are configured by using acceleration sensors, control means 12 can perform operation detection based on acceleration detection signals equal to or more than the predetermined values of motion detection means 13 and 14. Accordingly, the operation to device body 10 can be certainly performed.

Control means 12 can perform operation detection based on signals obtained by removing predetermined displaced portions (acceleration displaced portions returning to almost similar values within predetermined time) from the output signals of motion detection means 13 and 14. Thus, the operation to device body 10 can be certainly performed.

In the display device according to the embodiment, control means 12 can be configured by using a computer (CPU: Central Processing Unit) operated according to a program. The program can cause the computer to perform at least the aforementioned procedure to detect an operation. The program can be provided by using a recording medium or via a communication network (e.g., Internet).

### Second Exemplary Embodiment

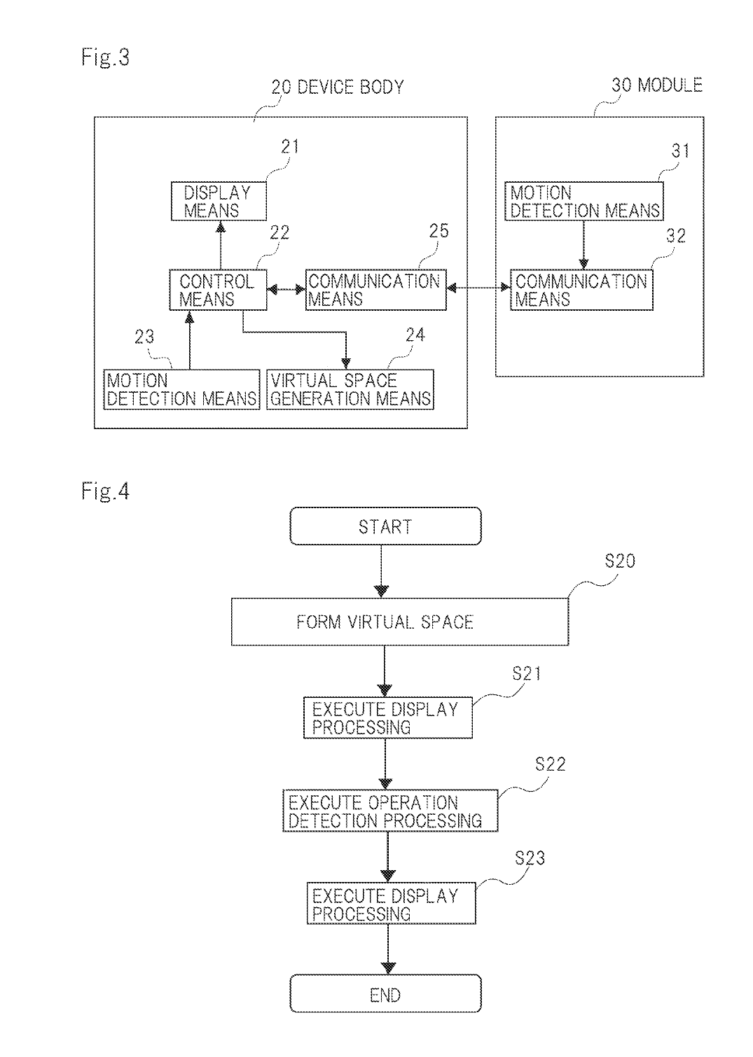

FIG. 3 is a block diagram showing the configuration of a virtual space access device according to the second exemplary embodiment of the present invention.

The virtual space access device shown in FIG. 3 includes device body 20 and module 30.

Device body 20 includes display means 21, control means 22, motion detection means 23, virtual space generation means 24, and communication means 25. Display means 21 and motion detection means 23 are similar to display means 11 and motion detection means 13 shown in FIG. 1. Though not shown in FIG. 3, device body 20 can include an output device such as a speaker and au input device such as a key or a touch panel.

Module 30, which is mounted or loaded on a holder, includes motion detection means 31 and communication means 32. Motion detection means 31 is similar to motion detection means 14 shown in FIG. 1. Module 30 can be configured as the mounting unit of, for example, an earphone, a headphone, glasses, a hat, or accessories.

Virtual space generation means 24, which stores data for forming a two-dimensional or three-dimensional virtual space, forms a virtual space based on the stored data according to an instruction signal from control means 22. Display means 21 displays a partial region of the virtual space according to a display control signal from control means 22.

Communication between communication means 25 and communication means 32 is carried out by wireless or via a communication line. The wireless communication is communication using a radio wave, light, or a sound and, for example, near field communication such as infrared communication can be used.

Control means 22 obtains the detection result of motion detection means 31 via communication means 25 and 32. Control means 22 obtains the detection results of motion detection means 23 and 31 at every fixed time, detects an operation to device body 20 based on the obtained detection results, and controls the displaying of display means 11 according to the detected operation.

Next, the operation of the virtual space access device according to the embodiment will be described.

FIG. 4 is a flowchart showing one procedure that is carried out ensure access in the virtual space access device according to the embodiment.

Control means 22, which has received the instruction for displaying the virtual space via the input device, supplies an instruction signal indicating the formation of a virtual space to virtual space forming means 24, and then virtual space forming means 24 forms a virtual space according to the instruction signal (step S20).

Then, control means 22 supplies a display control signal indicating displaying of the predetermined region of the virtual space to display means 21, and then display means 21 displays the predetermined region of the virtual space according to the display control signal (step S21).

Then, control means 22 obtains the detection results of motion detection means 23 and 31 at every fixed time, and detects an operation to device body 20 based on the obtained detection results (step S22). This procedure to detect an operation is performed through the same procedure as that of the operation detection processing shown in FIG. 2.

Lastly, control means 22 supplies a display control signal based on the operation detected in step S22, and display means 21 changes the display position in the virtual space according to the display control signal (step S23).

According to the aforementioned access process, for example, operations unintended by the user and based on the movement or the attitude change of the holder can be removed. Thus, a desired region in the virtual space can be certainly displayed on display means 21, in other words, accurate accessing of the virtual space can be achieved.

Hereinafter, effects will be described by citing a specific situation.

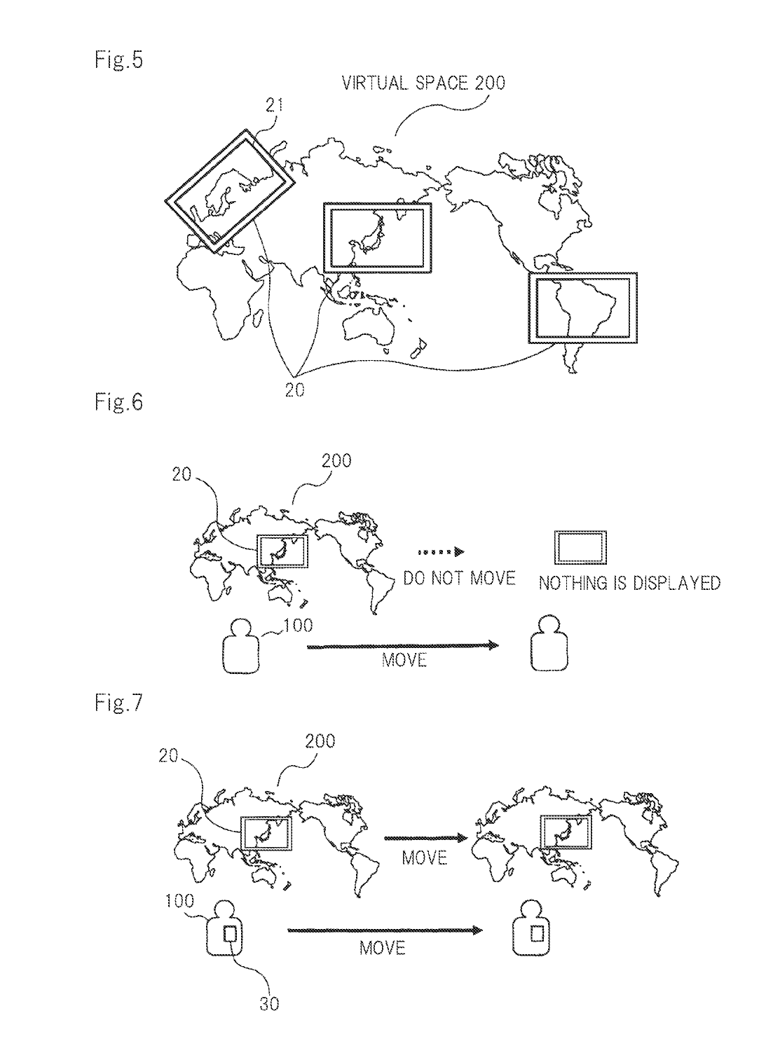

FIG. 5 shows an example of accessing the virtual space not accompanied by any movement such as walking by a user.

Referring to FIG. 5, there is formed virtual space 200 of a world map. The user can hold device body 20 with one hand. The user can move device body 20 to a desired position in virtual space 200 to display, on display means 21, a video regarding the desired position in virtual space 200.

FIG. 6 shows, as a comparative example, an example of accessing the virtual space accompanied by movement such as walking by a user but not using module 30.

In the comparative example shown in FIG. 6, module 30 is not mounted on user 100. Control means 22 detects an operation based on only the detection result of motion detection means 23. In this case, when user 100 moves, device body 20 moves out of the virtual space, and nothing is displayed on display means 21.

FIG. 7 shows an example of accessing the virtual space accompanied by movement such as walking by a user. Module 30 is mounted on user 100. Control means 22 detects an operation based on the detection results of motion detection means 23 and 31. In this case, when user 100 moves, device body 20 does not move out of the virtual space, and the video at the desired position in the virtual space is displayed on display means 21.

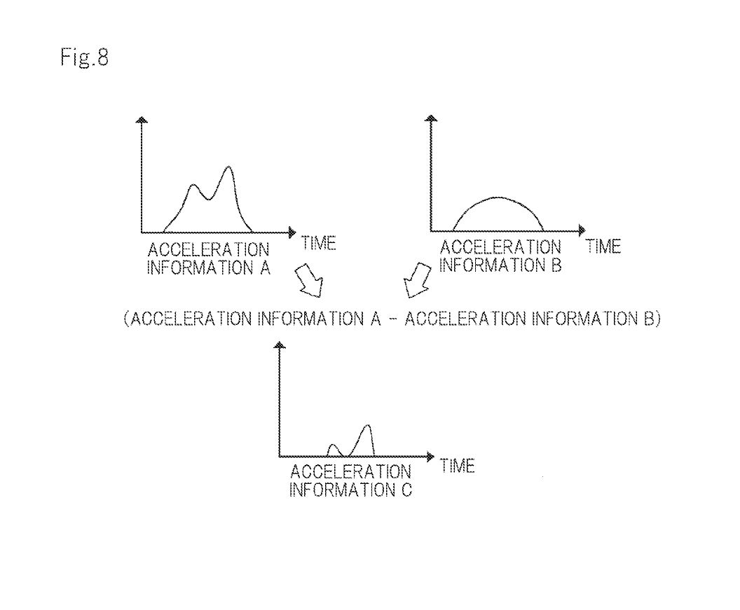

FIG. 8 shows an example of acceleration information when motion detection means 23 and 31 are configured by using acceleration sensors.

As shown in FIG. 8, motion detection means 23 outputs acceleration information A while motion detection means 31 outputs acceleration information B. Acceleration information A includes the motion component of device body 20 accompanying the operation, and the motion component of device body 20 accompanying the movement of user 100. Acceleration information B includes the motion component of user 100. Acceleration information B is subtracted from acceleration information A to obtain acceleration information C as the motion component of device body 20 accompanying the operation. Thus, as shown in FIG. 7, in the case of the motion component accompanied by the movement of user 100, control means 23 can detect the operation to device body 20 based on acceleration information C obtained by subtracting acceleration information B from acceleration information A.

In the virtual space access device according to the embodiment, virtual space forming means 24 can be disposed separately from device body 20.

When motion detection means 23 and 31 are configured by using acceleration sensors, control means 22 can perform operation detection based on acceleration detection signals equal to or more than the predetermined values of motion detection means 23 and 31 Accordingly, minute oscillation of the virtual space can be prevented, and accessing a desired space region can be certainly carried out.

Control means 22 can perform procedure to detect an operation based on signals obtained by removing predetermined displaced portions (acceleration displaced portions returning to almost similar values within predetermined time) from the output signals of motion detection means 23 and 31. Thus, minute oscillation of the virtual space can be prevented, and accessing the desired space region can be certainly carried out.

In the virtual space accessing device according to the embodiment, control means 22 can be configured by using a computer operated according to a program. The program can cause the computer to perform at least the aforementioned access process. The program can be provided by using a computer readable recording medium, for example, an optical disk such as a CD (Compact Disc) or a DVD (Digital Video Disc), a LISB (Universal Serial Bus) or a memory card, or via a communication network (e.g., Internet).

The device of the present invention described above can be applied to a mobile device (mobile terminal such as tablet terminal or notebook personal computer, or mobile phone), a head mount display, a spectacle display device, and a game machine.

The present invention has been described by ways of embodiment. However, the present invention is not limited to the embodiment. Various changes understandable to those skilled in the art can be made to the configuration and the operations of the present invention without departing from the spirit and scope of the present invention.

This application claims priority from Japanese Patent Application No. 2011-207779 filed Sep. 22, 2011, which is hereby incorporated by reference herein in its entirety.

1. A display device comprising:
a device body that includes a display unit;
a first motion detection unit that detects motion of the device body;
a second motion detection unit that detects motion of a holder that holds the device body; and
a control unit that detects an operation of the device body based on detection results of the first and second motion detection units, and that cotrols displaying of the display unit according to the detected operation.

2. The display device according to claim 1, wherein:
the first motion detection unit detects at least one of movement and an attitude change of the device body; and
the second motion detection unit detects at least one of movement and an attitude change of the holder.

3. The display device according to claim 1, wherein the control unit detects the operation of the device body based on a result of subtracting the detection result of the second motion detection unit from the detection result of the first motion detection unit.

4. The display device according to claim 1, further comprising a virtual space forming unit that forms a virtual space,
wherein the control unit causes the display unit to display a video of a partial region of the virtual space, and changes a display region in the virtual space displayed by the display unit according to the operation of the device body that has been detected based on the detection results of the first and second motion detection units.

5. The display device according to claim 1, wherein:
the first and second motion detection units are acceleration sensors; and
the control unit detects the operation of the device body based on output signals of the first and second motion detection units equal to or more a predetermined value.

6. The display device according to claim 1, wherein:
the first and second motion detection units are acceleration sensors; and
the control unit detects the operation of the device body based on signals obtained by removing portions indicating predetermined displacements from output signals of the first and second motion detection units.

7. The display device according to claim 1, wherein:
the second motion detection unit includes a plurality of acceleration sensors; and
the control unit obtains a detection result indicating an average value among output values of the plurality of acceleration sensors from the second motion detection unit.

8. The display device according to claim 1, wherein:
the second motion detection unit detects a center of gravity of the holder; and
the control unit obtains a detection result indicating a change in center of gravity of the holder from the second motion detection unit.

9. A display control method comprising:
detecting motion of a device body that includes display means, and detecting motion of a holder that holds the device body; and
detecting an operation of the device body based on the motion detection result of the device body and the motion detection result of the holder, and controlling displaying of the display means according to the detected operation.

10. A non-transitory computer readable storage medium storing a computer program, the program causing a computer to execute:
processing for detecting, based on a first detection result of detecting motion of a device body that includes display means and a second detection result of detecting motion of a holder that holds the device body, an operation of the device body; and
processing of controlling displaying of the display means according to the detected operation.
